(19) United States
(12) Patent Application Publication
(10) Pub. No.: US 2007/0157433 A1
(43) Pub. Date: Jul. 12, 2007

(54) Positioning hinge

(75) Inventors: Sheng-Nan Lu, Shulin City (TW); Hsiang-Chi Chien, Shulin City (TW)

Correspondence Address: NIKOLAI & MERSEREAU, P.A., 900 SECOND AVENUE SOUTH, SUITE 820, MINNEAPOLIS, MN, 55402, US

(73) Assignee: SHIN ZU SHING CO., LTD., Shulin City (TW)

(21) Appl. No.: 11/328,365

(22) Filed: Jan. 9, 2006

(51) Int. Cl. E05D 11/08

(52) U.S. Cl. 16/342

(57) ABSTRACT

The positioning hinge has a pintle, a leaf assembly and a positioning element. The pintle is mounted in the leaf assembly and is connected with the positioning element. The leaf assembly has a surface, and the positioning element rubs against the positioning element to generate a growing friction. When the pintle and the leaf assembly are mounted to a cover and a body respectively, the growing friction generated by the positioning element and the leaf assembly makes the cover to be positioned at a desired position relative to the body.

### BACKGROUND OF THE INVENTION

1. Field of the Invention

The present invention relates to a positioning hinge, and more particular to a hinge used to strongly hold an object in a position.

2. Description of Related Art

Hinges are widely used on covered electronic devices such as notebook computers or pocket game computers. The covered electronic devices often have a body and a cover. The cover often has a built-in monitor and is attached pivotally to the body by hinges to raise or lower.

Although conventional hinges mounted on a covered electronic device allow the cover to be raised, they normally have no capability to hold the cover in a desired position, which would probably causes the cover to drop and strike the body when the cover is raised.

Even if conventional hinges can position the cover, they only provide weak support that is inadequate to overcome the torque generated by the weight of the cover, and the cover may possibly strike the body.

The shortcomings addressed make conventional hinges difficult to use.

To overcome the shortcomings, the present invention provides a positioning hinge to obviate or mitigate the aforementioned problems.

### SUMMARY OF THE INVENTION

The main objective of the present invention is to provide a positioning hinge that can strongly hold an object mounted on the hinge in a position.

The positioning hinge comprises a pintle, a leaf assembly and a positioning element. The pintle is mounted in the leaf assembly and connects to the positioning element. The leaf assembly has a surface to rub against the positioning element to generate a growing friction. With the pintle and the leaf assembly being mounted in a cover and a body respectively, the growing friction generated by the positioning element and the leaf assembly will make the hinge strongly hold the cover relative to the body and keep the cover from striking the body.

Other objectives advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a positioning hinge in accordance with the present invention;

FIG. 2 is an exploded perspective view of the positioning hinge in FIG. 1;

FIG, 3 is an operational end view of the positioning hinge in FIG. 1 in a closed position;

FIG. 4 is an operational end view of the positioning hinge in FIG. 1 being turned;

FIG. 5 is an operational end view of the positioning hinge in FIG. 1 in an open position;

FIG. 6 is a perspective view of a second embodiment of a positioning hinge in accordance with the present invention;

FIG. 7 is an exploded perspective view of the positioning hinge in FIG. 6;

FIG. 8 is a top view of a third embodiment of a positioning hinge in accordance with the present invention;

FIG. 9 is an exploded perspective view of the positioning hinge in FIG. 8;

FIG. 10 is an operational end view of the positioning hinge in FIG. 6 in a closed position;

FIG. 11 is an operational end view of the positioning hinge in FIG. 6 being tumed;

FIG. 12 is an operational end view of the positioning hinge shown in FIG. 6 in an open position;

FIG. 13 is a referential perspective view of two positioning hinges in accordance with the present invention mounted on a notebook computer.

### DETAILED DESCRIPTION OF THE PREFERRED EMBODIMENT

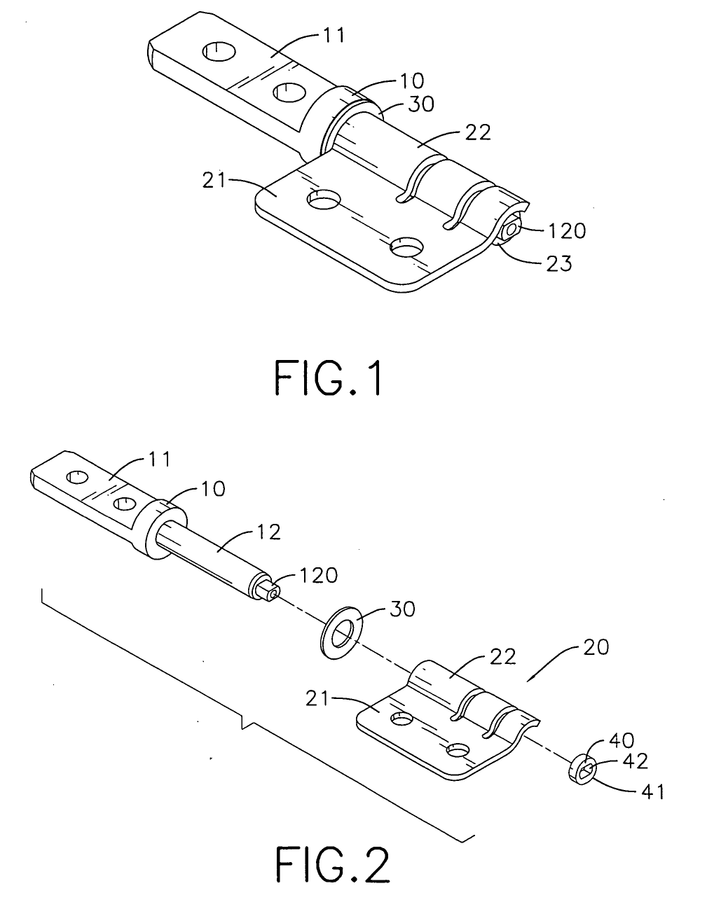

With reference to FIGS. 1, 2, 7 and 9, the positioning hinge in accordance to the present invention comprises a leaf assembly (20, 20′, 20″), a pintle (10), an optional washer (30) and a positioning element (40, 40′).

The leaf assembly (20, 20′, 20″) has a leaf (21) and a barrel (22, 22′, 22″).

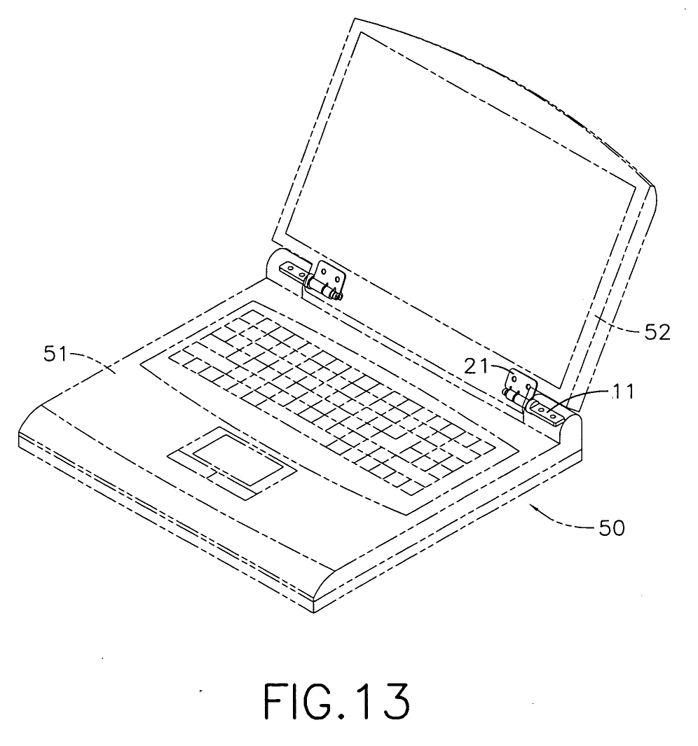

With further reference to FIG. 13, the leaf (21) is attached securely to a cover (52) of an object like a notebook computer (50).

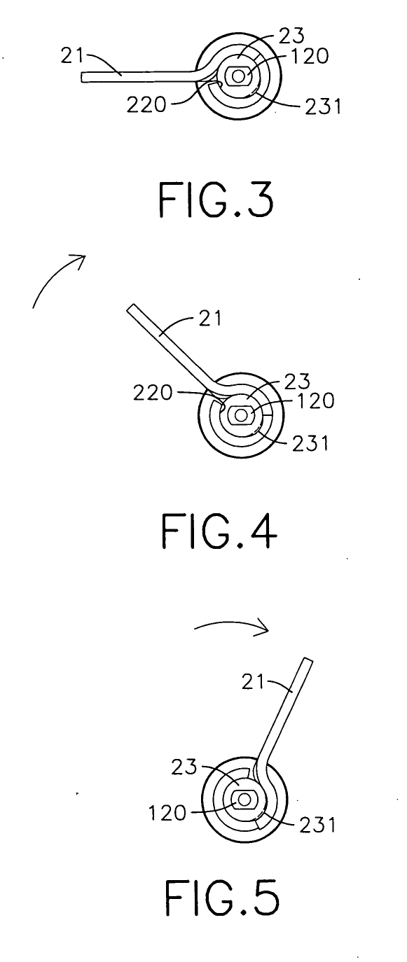

With reference to FIGS. 1, 2 and 3 to 5, the positioning hinge in the first embodiment comprises a leaf assembly (20), a pintle (10), an optional washer (30) and a cam (40) as positioning element.

The barrel (22) of the leaf assembly (20) is tubular and has a proximal end, a distal end, a longitudinal gap and an inner surface (220). The longitudinal gap is formed from the proximal end to the distal end and allows the barrel (22) to expand slightly. The inner surface (220) is formed inside the barrel (22).

The pintle (10) has a proximal end, a distal end, a connector (11) and a shaft (12). The connector (11) is defined on and protrudes longitudinally from the proximal end of the pintle (10) and can be mounted in a body (51) (with reference to FIG. 13). The shaft (12) is defined on the distal end, which extends through the washer (30) and mount into the barrel (22) of the leaf assembly (20) and has a distal end and a non-circular sectional axle (120) formed on the distal end.

The cam (40) that has a center, a salient (41) and a connecting hole (42). The connecting hole (42) is formed at the center of the cam (40), and is corresponding and mounted to the axle (120) of the pintle (10). The salient (41) can rub against the inner surface (220), and pressed by the inner surface (220) gradually in compliance with a turned angle to generate a growing friction to strongly hold the cover (52) in a position.

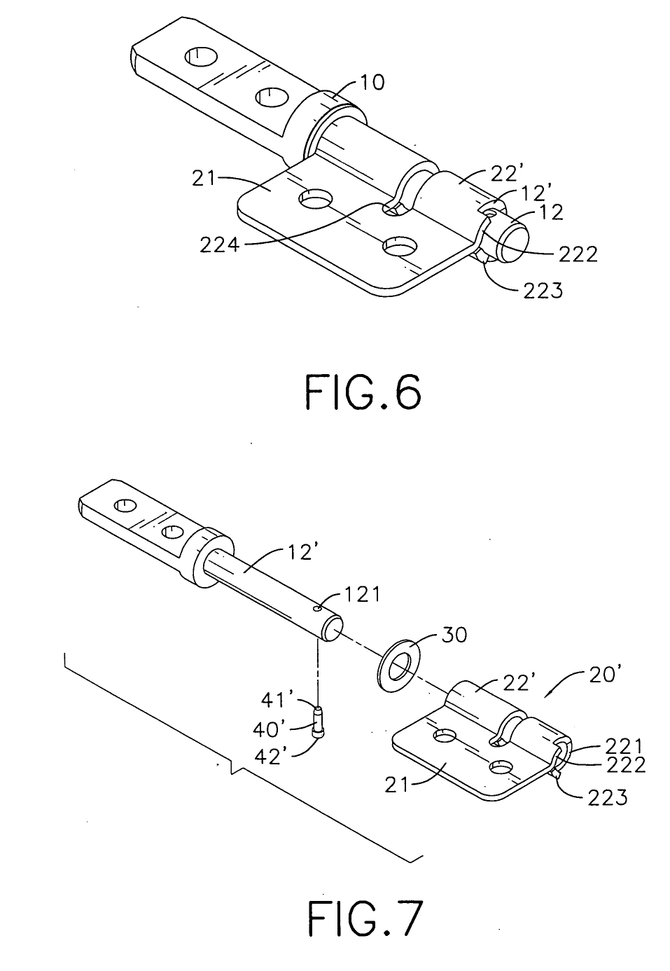

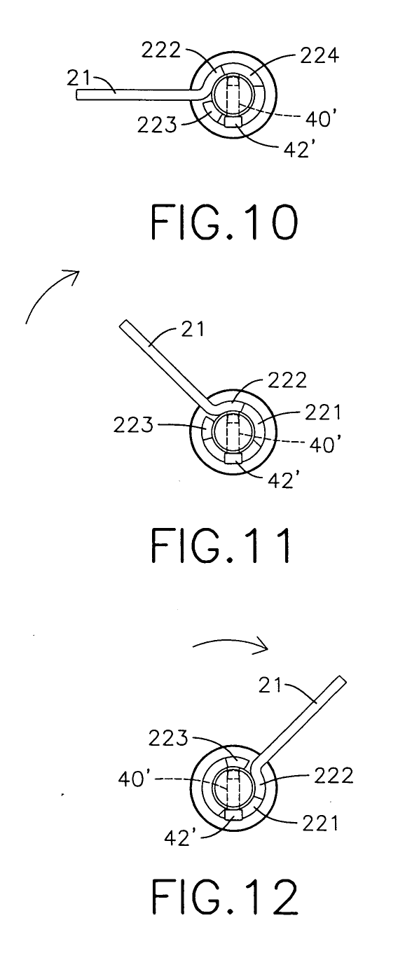

With reference to FIGS. 6, 7 and 10 to 12, the positioning hinge in the second embodiment comprises a leaf assembly (20′), a pintle (10), an optional washer (30) and a rod (40′) as a positioning element. The leaf assembly (20′) has a leaf (21) and a barrel (22′). The barrel (22′) is tubular and has a middle, a cutout (224), a side end, two flanges (222)(223) and a sloping surface (221). The cutout (224) is defined on the middle and has two sectional surfaces. The sloping surface (221) is formed on the side end. The flanges (222)(223) are formed on the side end separately.

The pintle (10) has a proximal end, a distal end, a connector (11) and a shaft (12′). The connector (11) is defined on and protrudes longitudinally from the proximal end of the pintle (10) and can be mounted in a body (51) (with reference to FIG. 13). The shaft (12′) is defined on the other end, which passes through the washer (30) and mounts into the barrel (22′) of the leaf assembly (20′) and has a distal end and a mounting hole (121) radially formed near the distal end.

The rod (40′) has a mounting end (41′) and a head (42′). The mounting end (41′) is mounted in the mounting hole (121) and the head (42′) is rub against the sloping surface (221) to generate a growing friction to make the hinge in accordance to the present invention be able to strongly hold the cover (52) in a position.

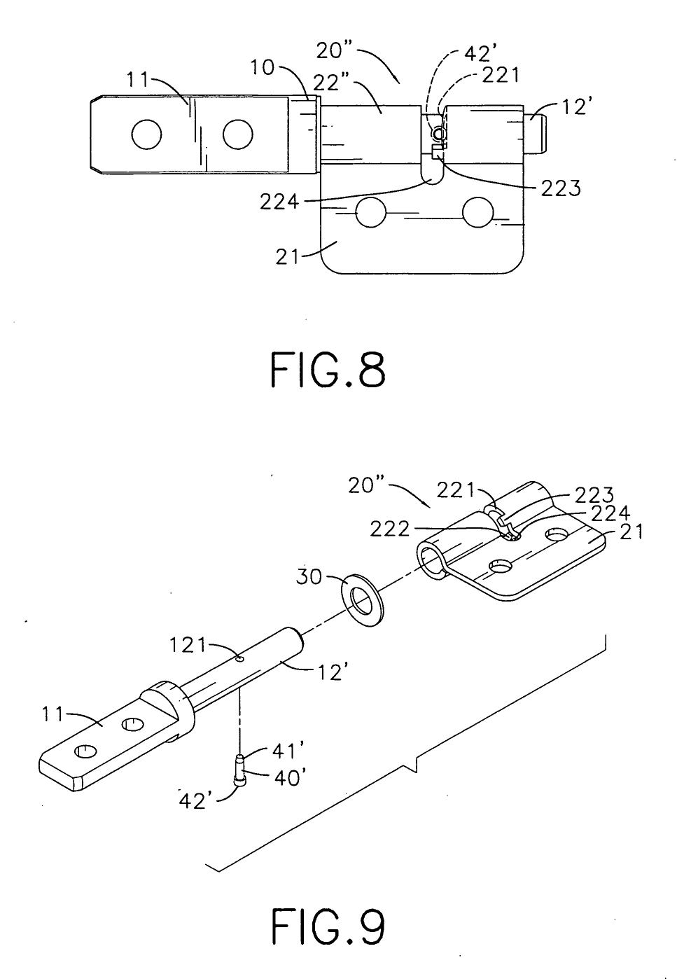

With reference to FIG. 8, 9, in the third embodiment, the said sloping surface (221) and the flanges (222)(223) are formed on one sectional surfaces of the cutout (224), and the said mounting hole (121) is also formed on the middle of the shaft (12′). Such that the rod (40′) is located at the middle of the shaft (12′) and the head (42′) rubs against the sloping surface (221) to generate a growing friction and provide the same effect.

With reference to 10, 11 and 12, the rod (40′) is wedged by the flanges (222)(223) to limit the rotational angle of the cover (52).

With further reference to FIG. 13, when the cover (52) is raised, the first leaf (21) mounted in the cover (52) is turned round simultaneously. When the cover (52) is turned, the positioning element (40, 40′) rubs against the surface (220,221) consequentially and generates a growing friction. With the growing friction, the hinge in accordance to the present invention is then able to strongly hold the raised cover (52) in a position.

Even though numerous characteristics and advantages of the present invention have been set forth in the foregoing description together with details of the structure and function of the invention, the disclosure is illustrative only. Changes may be made in detail especially in matters of shape, size, and arrangement of parts-within the principles of the invention to the full extent indicated by the broad general meaning of the terms in which the appended claims are expressed.

What is claimed is:

1. A positioning hinge comprising:
a leaf assembly having
a leaf and
a barrel connected to the leaf and having a middle;
a proximal end;
a side end; and
a surface;
a pintle attached to the leaf assembly and having
a proximal end;
a distal end;
a connector defined on and protruding longitudinally from the proximal end of the pintle; and
a shaft defined on the distal end of the pintle, and mounted into the barrel of the leaf assembly and having a distal end; and
a positioning element mounted on the distal end of the shaft and rubbing against the surface of the barrel.

2. The positioning hinge as claimed in claim 1, wherein
the pintle further has an axle being non-circular sectional and formed on the distal end; and
the barrel further has a longitudinal gap being formed from the proximal end to the distal end and allowing the barrel to expand slightly and the surface being an inner surface formed inside the barrel.

3. The positioning hinge as claimed in claim 2, wherein the positioning element is a cam having
a center;
a connecting hole formed at the center, and corresponding and mounting on the axle of the pintle; and
a salient rubbing against the inner surface of the barrel.

4. The positioning hinge as claimed in claim 1, wherein
the surface is a sloping surface formed on the side end of the barrel;
the pintle further has a mounting hole radially formed near the distal end.

5. The positioning hinge as claimed in claim 4, wherein the positioning element is a rod having
a mounting end mounted in the mounting hole;
a head rubbing against the sloping surface.

6. The positioning hinge as claimed in claim 1, wherein
the barrel further has
a cutout defined at the middle and having two sectional surfaces;
the surface is a sloping surface formed on one of the sectional surfaces;
the pintle further has a mounting hole formed in the middle of the shaft.

7. The positioning hinge as claimed in claim 6, wherein the positioning element is a rod having
a mounting end mounted in the mounting hole;
a head rubbing against the sloping surface.

8. The positioning hinge as claimed in claim 5, wherein the barrel further has two flanges formed on the side end separately.

9. The positioning hinge as claimed in claim 7, wherein the barrel further has two flanges formed on the sloping surface separately.

10. The positioning hinge as claimed in claim 1 further comprising a washer mounted on the shaft.

11. The positioning hinge as claimed in claim 3 further comprising a washer mounted on the shaft.

12. The positioning hinge as claimed in claim 5 further comprising a washer mounted on the shaft.

13. The positioning hinge as claimed in claim 7 further comprising a washer mounted on the shaft.
